(19) United States
(12) Patent Application Publication
(10) Pub. No.: US 2022/0379698 A1
(43) Pub. Date: Dec. 1, 2022

(54) Vehicle Cover with Access Opening

(71) Applicant: Robert Prado, Whittier, CA (US)

(72) Inventor: Robert Prado, Whittier, CA (US)

(21) Appl. No.: 17/331,207

(22) Filed: May 26, 2021

(51) Int. Cl. B60J 11/04

(52) U.S. Cl. CPC B60J 11/04

(57) ABSTRACT

A car cover includes openable panels aligned with windows and/or doors. The panels may include zippers, hook and loop fasteners, or other attachments to hold the panels in position over the windows and doors. Screens may reside with the window panels. The panels may be permanently or semi-permanently attached along bottom edges. The door panel be include separable portions for front and rear doors.

### BACKGROUND OF THE INVENTION

The present invention relates to car covers and in particular to custom car covers with openings aligned with car windows and doors.

Many vehicle owners desire to protect their vehicles from environmental effects and keep the vehicles clean. In some cases the vehicle owners may desire to camp-out in their vehicles. Known car covers to not allow ventilation through door windows, or access to the interior with the cover in place.

### BRIEF SUMMARY OF THE INVENTION

The present invention addresses the above and other needs by providing a car cover which includes openable panels aligned with windows and/or doors. The panels may include zippers, hook and loop fasteners, or other attachments to hold the panels in position over the windows and doors. Screens may reside with the window panels. The panels may be permanently or semi-permanently attached along bottom edges. The door panel be include separable portions for front and rear doors.

In accordance with one aspect of the invention, there is provided car cover with openable panels and screens aligned with door windows. The panels include zippers or the like along sides and top. One or more panel may be opened and folded down to allow fresh air into the car. The screens may be opened to allow access to the car interior

In accordance with another aspect of the invention, there is provided car cover with openable panels aligned with car doors. The panels include zippers or the like along sides and top. One or more panel may be opened and folded down to allow access to the car interior.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 shows a car with doors and windows.

FIG. 2 shows the car with a car cover including openable window and door panels according to the present invention.

FIG. 3 shows the car and the car cover, with window panels opened according to the present invention.

FIG. 4 shows the car and the car cover, with the door panel opened according to the present invention.

FIG. 5 shows zipper or the like for retaining closed window panels and closed screens according to the present invention.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

Where the terms “about” or “generally” are associated with an element of the invention, it is intended to describe a feature's appearance to the human eye or human perception, and not a precise measurement, or typically within 10 percent of a stated value.

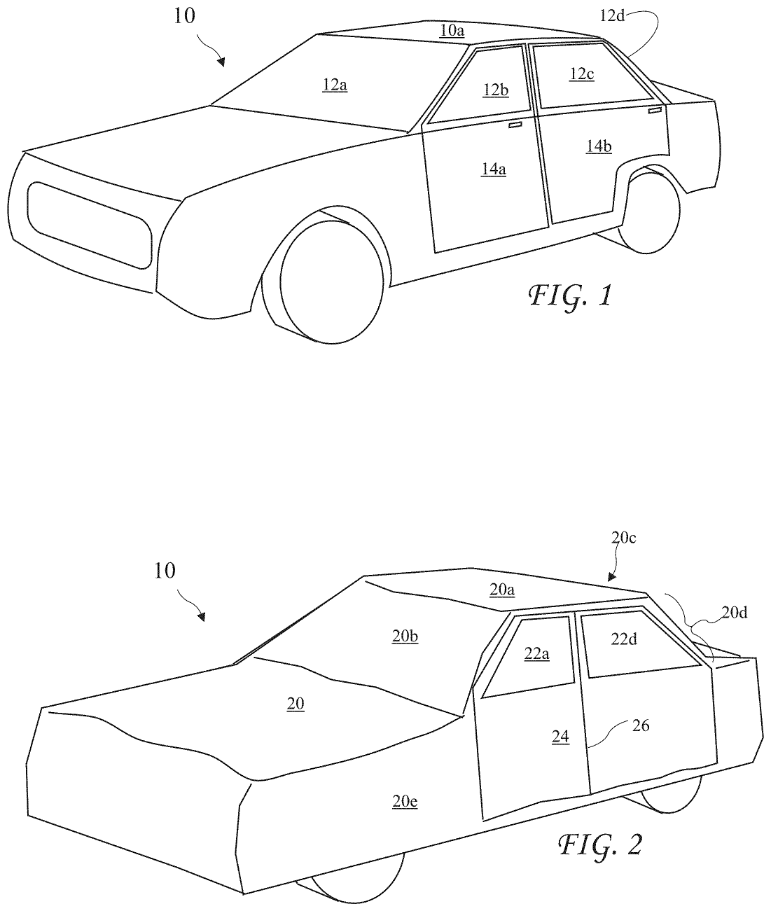

A car 10 is shown in FIG. 1 with a roof 10a, doors 14a and 14b, a windshield 12a, door windows 12b and 12c, and rear window 12d.

The car 10 covered by a car cover 20 is shown in FIG. 2. The car cover 20 may cover the entire car 20 or may only substantially cover the roof 10a and windows 12a, 12b, 12c, and 12d, where an bottom edge may extend farther but merely within manufacturing tolerances and to allow one top to fit more then one car model. The car cover 20 includes a to portion 20a, windshield portion 20b, a rear window portion 20c, and door window portions 20d. The car cover may also include a lower portion 20e covering a lower portion of the car body.

The car cover 20 includes openable window panels 22a and 22b, and an openable door panel 24, The door panel 24 may include a vertical separation 26 allowing a portion over one door to be opened separately. Screens 23 may be provided over the door windows 12b and 12c, and may be opened in the same manner as the window panels 22a and 22b are opened.

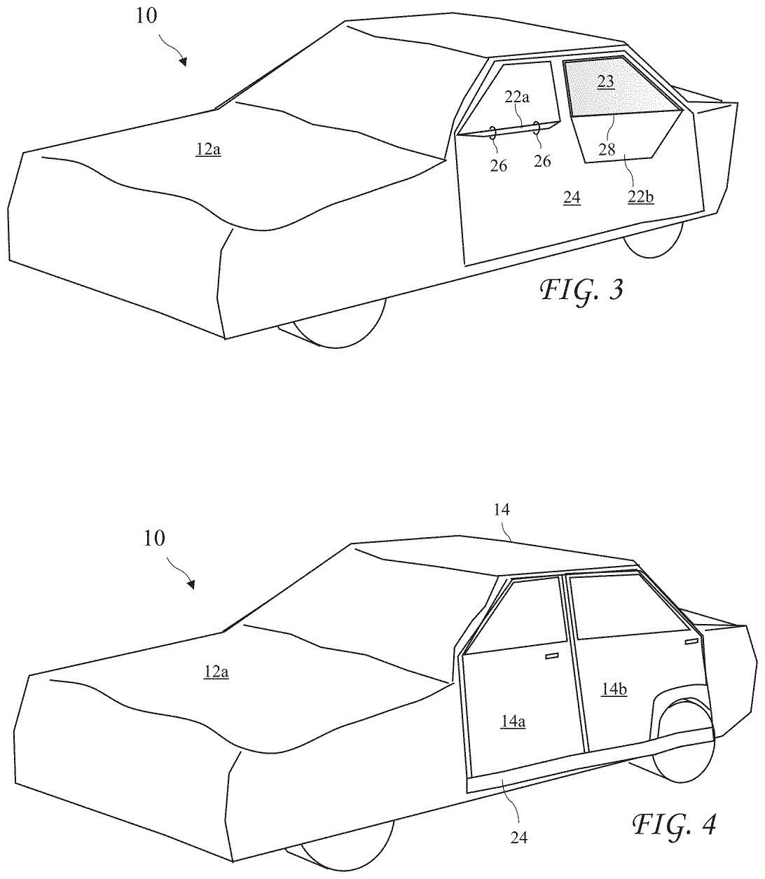

The car 10 and the car cover 20, with window panels 22a and 22b opened is shown in FIG. 3. The window panel 22a is shown gathered, for example in ties 26, and the window panel 22b hangs from a permanent or semi permanent seam 28.

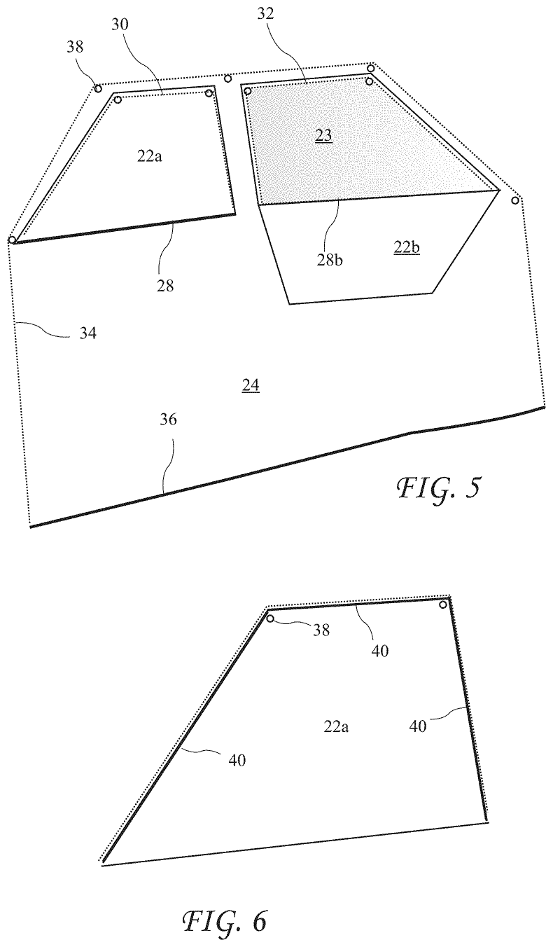

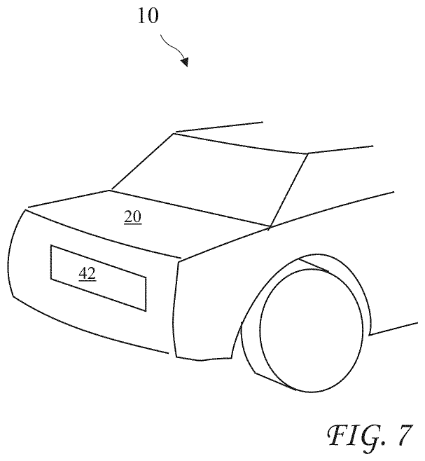

FIG. 4 shows the car 10 and the car cover 20, with the door panel 24 opened and rolled. The doors 14a and 14b are exposed and may be opened.

First seam closures 30 retain closed window panels 22a and 22b closed, and seam closures 32 retain closed screens 23, are shown in FIG. 5. The seam closures may be zippers, a hook and loop fastener, or the like. The permanent or semi permanent seams 28 and 28b along the bottom of the window panels 22a and 22b and screens 23 retain the window panels 22a and 22b and screens 23 after the seam closures are released. Third side and top seam closures 34 retain the closed door panel 24 and a perm anent or semi permanent seam 36 retains the bottom of the door panel 24. The seam closures may be zippers, a hook and loop fastener, or the like. Point fasteners 38, for example snaps or buttons, on corners of the window panels 22a and 22b, screens 23, and door panel 24 may alternatively be used to close the window panels 22a and 22b, screens 23, and door panel 24.

Flexible rods 40 are shown along top and side edges of the window panel 22a in FIG. 6. The window panel 22b, screen 23, and door panel 24 may also include the flexible rods 40 along top and side edges. When point fasteners 38 are used to hold the window panel 22b, screen 23, and door panel 24 closed, the flexible rods 40 help the window panel 22b, screen 23, and door panel 24 retain their shape.

A pocket 42 may be attached to the car cover 20 is shown in FIG. 7, to pack the car cover 20 when not in use.

While the invention herein disclosed has been described by means of specific embodiments and applications thereof, numerous modifications and variations could be made thereto by those skilled in the art without departing from the scope of the invention set forth in the claims.

I claim:

1. A car cover comprising:
a top portion configured to cover a car roof;
a windshield portion configured to cover a car windshield;
a rear window portion configured to cover a car rear window;
door window portions configured to cover car door windows; and
at least one openable window panel residing over car door windows.

2. The car cover of claim 1, wherein a screen resides under the at least one window panel.

3. The car cover of claim 1, wherein the at least one window panel is held closed by a zipper.

4. The car cover of claim 1, wherein the at least one window panel is held closed by hook and loop material.

5. The car cover of claim 1, wherein the at least one window panel is held closed by point fasteners.

6. The car cover of claim 5, wherein flexible rods are attached along sides and edges of the at least one window panel.

7. The car cover of claim 1, further including an openable door panel residing over at least one car door.

8. The car cover of claim 7, wherein the at least one window panel is in the door panel.

9. The car cover of claim 1, further including a pouch attached to the car cover, for packing the car cover when not in use.

10. A car cover comprising:
a top portion configured to cover a car roof;
a windshield portion configured to cover a car windshield;
a rear window portion configured to cover a car rear window;
door window portions configured to cover car door windows;
openable window panels residing over car door windows, the openable window panels permanently attached to the car cover along bottom edges and detachably attached to the car cover along side and top edge; and
screens residing under the openable windows, the screens permanently attached to the car cover along screen bottom edges and detachably attached to the car cover along screen side and top edge.

11. A car cover comprising:
a top portion configured to cover a car roof;
a windshield portion configured to cover a car windshield;
a rear window portion configured to cover a car rear window;
door window portions configured to cover car door windows;
openable door panels residing over car doors, the door panels permanently attached to the car cover along door bottom edges and detachably attached to the car cover along door side and top edge.
openable window panels in the door panels residing over car door windows, the openable window panels permanently attached to the car cover along bottom edges and detachably attached to the car cover along side and top edge; and
screens residing under the openable windows, the screens permanently attached to the car cover along screen bottom edges and detachably attached to the car cover along screen side and top edge.
